(19) United States
(12) Patent Application Publication
(10) Pub. No.: US 2008/0127490 A1
(43) Pub. Date: Jun. 5, 2008

(54) Manufacture process of connector

(75) Inventor: Ted Ju, Keelung City (TW)

Correspondence Address: TROXELL LAW OFFICE PLLC, SUITE 1404, 5205 LEESBURG PIKE, FALLS CHURCH, VA, 22041, US

(73) Assignee: Lotes co., Ltd.

(21) Appl. No.: 11/607,051

(22) Filed: Dec. 1, 2006

(51) Int. Cl. H01R 43/20; H01R 12/00

(52) U.S. Cl. 29/876; 29/883; 439/78; 439/72; 205/135

(57) ABSTRACT

A manufacture process of a connector includes six steps of: (1) providing an insulating body; (2) providing a shelter with at least one slot; (3) the shelter being covered on the insulating body; (4) a metal pellet passing through the slot being plated with the insulating body to form a metal layer with a specific shape by a method of a physical plating membrane; (5) putting the insulating body into chemical liquid so that the metal layer of the insulating body being plated with at least one metal layer for protecting; and (6) taking the shelter off. Comparing to the prior art, the manufacture process of the connector uses a method of plating membrane to form a metal layer having the same function as a conductive terminal. By the method, the elastic contact portion can be installed on the two ends of the pressing contact connector.

### BACKGROUND OF THE INVENTION

(a) Field of the Invention

The present invention relates to manufacture processes of a connector, and in particular a manufacture process of a connector by a method of mental plating for electric conductivity.

(b) Description of the Prior Art

A connector of prior arts has an insulating body and a plurality of conductive terminals. The insulating body is formed by a manufacture process of ejecting from insulating materials. The conductive terminals of the insulating body are formed by metal material of pressing. Then the conductive terminals are installed in the insulating body to form the product of the connector. However, some connectors are asked for higher sensitivity and the conductive terminals of insulating body need to be installed precisely into the insulating body. For instance, China Patent No. 200420078252.8 is illustrated with the switch connector. The switch connector includes an insulating body 1, a fixing terminal 2, a moveable terminal 3, a moveable terminal 5 and a pressing portion 6. The fixing terminal 2 is in contact selectively with the moveable terminal 3 and the moveable terminal 5 by pressing the pressing portion 6. Due to be asked to higher sensitively, the switch connector can be fixed firmly in the insulating body. If parts of the fixing terminal protrude out or change shape, the switch connector can not be qualified for the required sensitivity so as not to be used normally. Besides, the connector is installed with a pressing contact terminal, the pressing contact terminal is easy to lost elasticity because of over pressing so that the connector can not be used normally.

Therefore, it is necessary to have a new style of an electric connector so as to overcome the above-mentioned defects.

### SUMMARY OF THE INVENTION

The primary objective of the present invention is to provide a manufacture process of a connector. The connector made by the manufacture process can be conductive accurately and ensure that the connector can be operated all the time with guarantee.

To achieve above object, the present invention provides a manufacture process of a connector including six steps of: (1) providing an insulating body; (2) providing a shelter with at least one slot; (3) the shelter being covered on the insulating body; (4) a metal pellet passing through the slot being plated with the insulating body to form a metal layer with a specific shape by a method of a physical plating membrane; (5) putting the insulating body into chemical liquid so that the metal layer of the insulating body being plated with at least one metal layer for protecting; and (6) taking the shelter off. Comparing to the prior art, the manufacture process of the connector uses a method of plating membrane to form a metal layer having the same function as a conductive terminal. By the method, the elastic contact portion can be installed on the two ends of the pressing contact connector.

### BRIEF DESCRIPTION OF THE DRAWINGS

FIG. 1 is a perspective view of the insulating body before planting with metal layers of the connector of the present invention.

FIG. 2 is illustrated with the first shelter of the present invention.

FIG. 3 is illustrated with the second shelter of the present invention.

FIG. 4 is a perspective view of the insulating body after plating with metal layers of the FIG. 1.

FIG. 5 is illustrated with the other angle view of the FIG. 4.

FIG. 6 is a partial cross-sectional view of plating the metal layer part of the insulating body of the FIG. 4.

FIG. 7 is an assembled perspective view of the connector of the present invention.

FIG. 8 is an exploded perspective view of the connector of the FIG. 7.

FIG. 9 is illustrated with the other angle view of the FIG. 8.

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

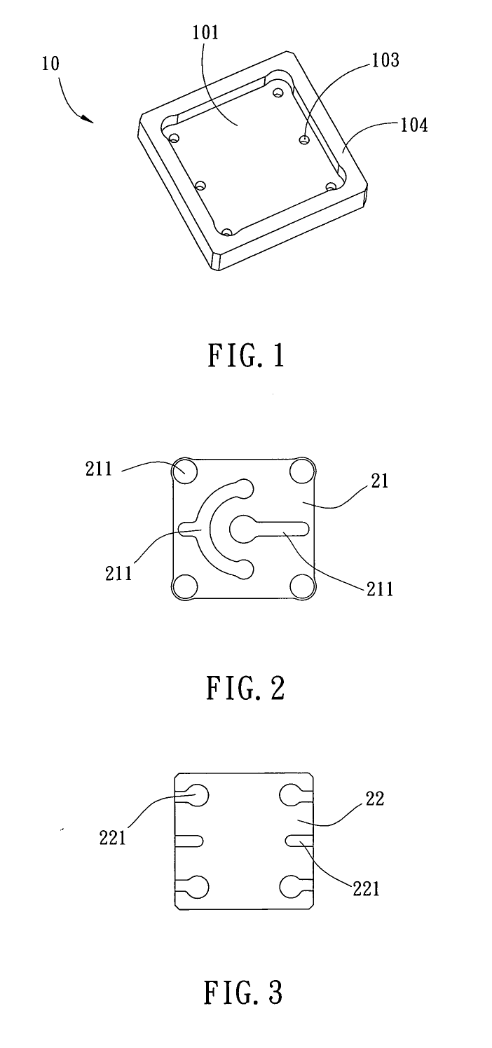

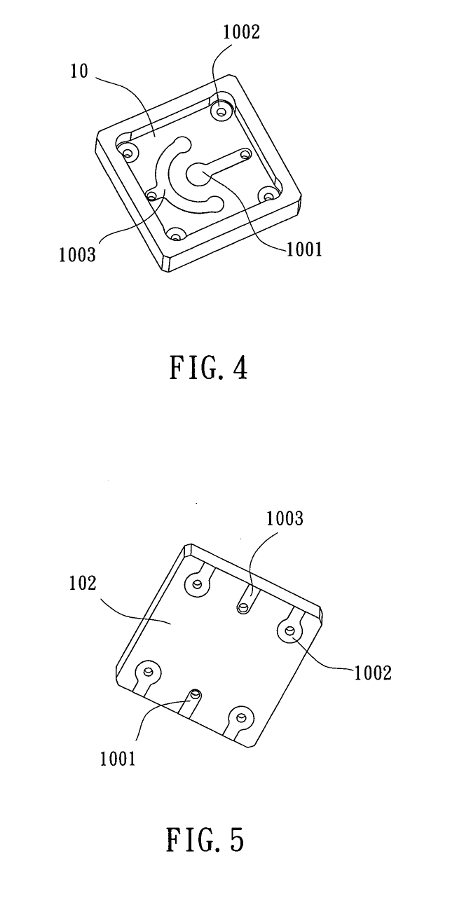

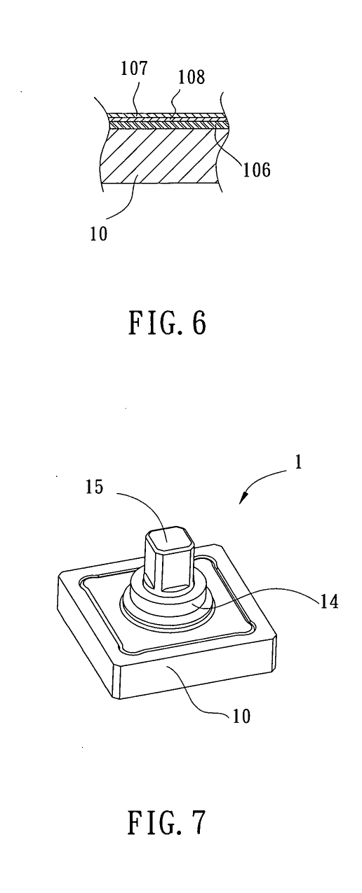

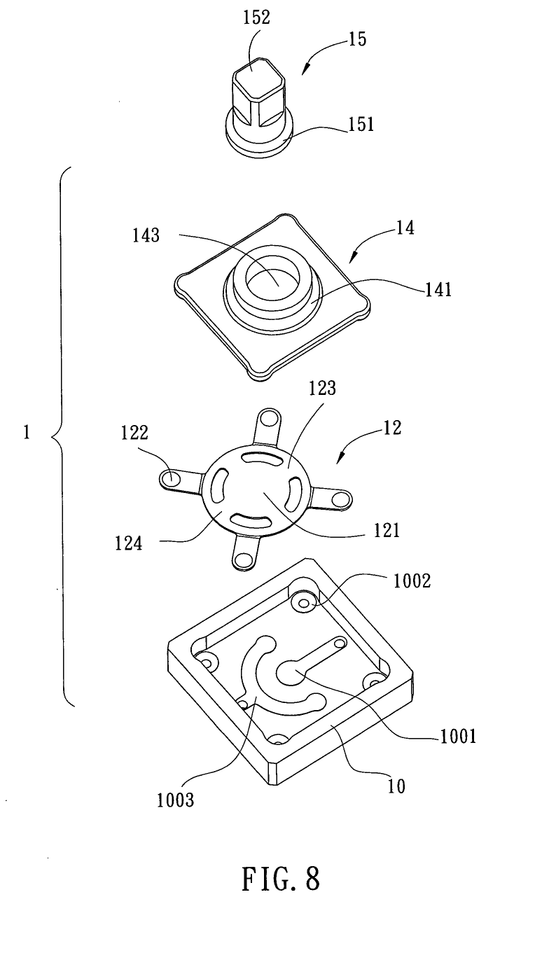

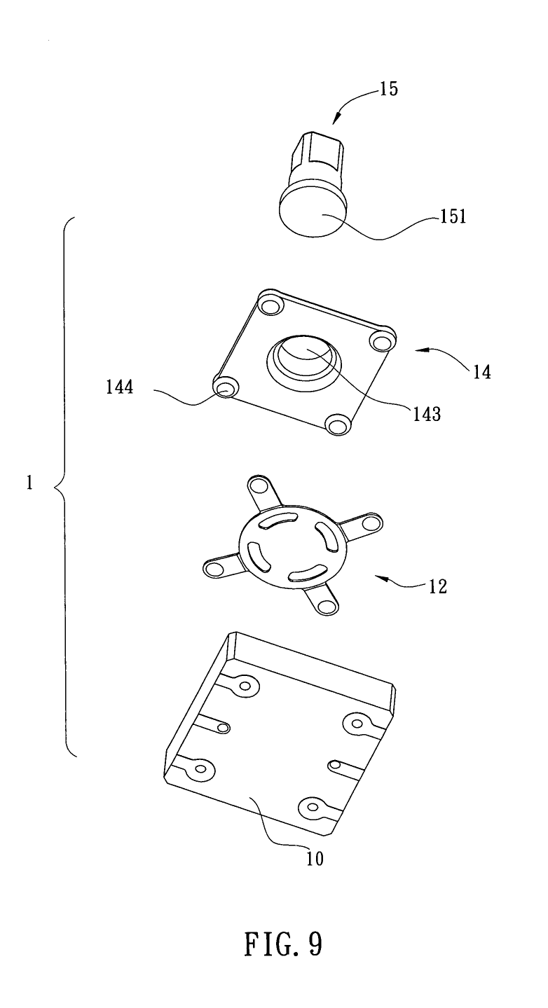

Referring to FIG. 1 to 9, the connector 1 of the present invention serves to connect an electric devise (such as a cell phone). The connector has an insulating body 10, a moveable terminal 12 and a pushing devise. The insulating body 10 has a retaining portion.

The manufacture process of the connector of the present invention is to install the retaining portion on the insulating body 10. The manufacture process has six major steps as the following descriptions. (1) Provide an insulating body 10. The insulating body 10 is made of engineering plastic. The insulating body 10 has an upper surface 101 and down surface 102. A passing hole 103 can pass through the upper surface 101 and down surface 102 of the insulating body 10. Besides, the circumference of the insulating body 10 has a first pushing devise 14. (2) Provide a first shelter 21 and a second shelter 22. The first shelter 21 and the second shelter 22 have a plurality of slots 211 and 221 depending on a user's demand. (3) The first shelter 21 and the second shelter 22 are covered on the upper surface 101 of the insulating body 10. Also, the slot 211 is aimed at the passing hole 103. Then the second shelter 22 is covered on the down surface 102. The slot 221 is aimed at the passing hole 103. (4) By the method of physic plating membrane (such as vacuum splashing plating), a metal pellet copper passing through the slot 211 and 221 is plated with the part of the slot 211 and 221 exposing on insulating body 10 and the inner surface of the passing hole 103 so as to form a metal layer 106 with a specific shape. (5) The insulating body 10 is intruded into chemical liquid (not shown). During the step (4) processing the physic plating membrane, the shelters are plated with a layer of metal. Besides, the insulating body 10 is intruded into chemical liquid for the plating, an electrode of the plating is conductive with the metal layer of the shelters during the step (4) so that the surface of the metal layer 106 of the insulating body 10 is plated again with the other metal layer 107 for protection thereof. The protecting metal layer 107 is made of nickel. Then a layer of gold 108 is plated on the protecting metal layer 107. (6) The first shelter 21 and the second shelter 22 are removed.

Also, the step (6) of removing the first shelter 21 and the second shelter 22 can be shifted to the step (4). After the step (4) removing the first shelter 21 and the second shelter 22, the insulating body 10 is intruded into the chemical liquid (not shown) to process the chemical plating. On the surface of the metal layer 106 can be plated with the metal layer 107. Then on the surface of the metal layer 107 is plated with a layer of gold. Even the step (4) has been shifted, the manufacture process of the connector can have the same function.

The retaining portion includes a central retaining portion 1001, a plurality of edge retaining portion 1002 positioned on the peripheral outside of the central retaining portion 1001, a public retaining portion 1003 positioned on the outside of the central retaining portion 1001. All of the central retaining portion 1001, the edge retaining portions 1002 and a public retaining portion 1003 should pass through the passing hole 103 and connect the inner surfaces of upper surface 101 and the down surface 102 of the insulating body 10.

The moveable terminal 12 has a central moveable portion 121 and a plurality of edge moveable portions 122 positioned at the peripheral of the central moveable portion 121. The central moveable portion 121 and the edge moveable portions 122 pass through a connecting portion 123 with about a circular shape so as to be connected and formed integrally. A public connecting portion 124 is formed on the connecting portion 123 between any two edge moveable portions 122.

The pushing devise has a first pushing devise 14 and a second pushing devise 15. The first pushing devise 14 is shaped approximately as a square. The middle of the first pushing devise 14 has a protruding portion 141 with a round platform shape. A guiding hole 143 is formed on the protruding portion 141 passing through the bottom of the first pushing devise 14. The second pushing devise 15 can be received partly moveably in the guiding hole 143 of the first pushing devise 14. A protruding portion 141 serves to press edge moveable portion 122 protruding out from the bottom of the first pushing devise 14. A protruding rim 151 extends from the bottom of the second pushing devise 15 to form as a pole structure. A pushing portion 152 is formed on the top of the pole.

When assembling, the central moveable portion 121 and the edge moveable portion 122 are aimed respectively at the central retaining portion 1001 and the edge retaining portion 1002. The pushing portion 152 of the second pushing devise 15 passes through the guiding hole 143 of the first pushing devise 14. Then the first pushing devise 14 and the second pushing devise 15 are positioned in the fixing position devise 104 of the insulating body 10. Thereby, the connector 1 is assembled and illustrated with the FIG. 7. The connector can be welded at an electric board of an electric devise (such as a cell phone). The second pushing devise 15 can be operated alternatively at a vertical direction or an inclined direction. By operating at the vertical direction, the central moveable portion 121 is conductive to the central retaining portion 1001. By operating at the inclined direction, the edge moveable portion 122 is conductive to the edge retaining portion 1002. Surely, a metal cover can be installed on the insulating body 10 of the connector for covering thereof.

The manufacture process of the connector uses the method of plating membrane to form a metal layer having the same function as a conductive terminal. The present invention can avoid the problem of the prior art, because the prior art can not fix firmly the fixing terminal. The connector can be conductive accurately. By the method, the elastic contact portion can be installed on the two ends of the pressing contact connector. The elastic contact portion is plated with a metal layer having the same function as the conductive terminals so that the method can avoid to lost elasticity for over pressing of the pressing contact conductive terminal. The present invention can be operated normally all the time with guarantee.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A manufacture process of a connector comprising six steps of:
(1) providing an insulating body;
(2) providing a shelter with slots;
(3) the shelter being covered on the insulating body;
(4) a metal pellet passing through the slot being plated with the insulating body to form a metal layer with a specific shape by a method of a physical plating membrane;
(5) the insulating body being intruded into chemical liquid so that the metal layer of the insulating body being plated with at least one metal layer for protecting; and
(6) taking the shelter off.

2. The manufacture process of connector as claimed in claim 1, wherein the metal pellet is made of copper.

3. The manufacture process of the connector as claimed in claim 1, wherein the metal layer for protecting is made of nickel.

4. The manufacture process of the connector as claimed in claim 1, wherein the outside of the protecting metal layer is plated with a layer of gold.

5. The manufacture process of the connector as claimed in claim 1, wherein the insulating body has an upper surface and a down surface; and the upper surface and the down surface are plated with metal layers.

6. The manufacture process of the connector as claimed in claim 1, wherein the insulating body has a passing hole; the passing hole is plated with a meter layer and is connected to the metal layers of the upper surface and the down surface of the insulating body.

7. The manufacture process of the connector as claimed in claim 1, wherein the insulating body has a fixing position devise for fixing with the shelters each other.

8. The manufacture process of the connector as claimed in claim 1, wherein the shelters are plated with metal layer at the step (4) for processing physical plating membrane; and when the insulating body is intruded into chemical liquid at the step (4) for plating, an electrode of the plating is conductive to the metal layers of the shelters.

9. The manufacture process of the connector as claimed in claim 1, wherein a method of physical plating membrane is vacuum splashing plating.

10. A manufacture process of a connector comprising six steps of:
(1) providing an insulating body;
(2) providing a shelter with at least one of slots;
(3) the shelter being covered on the insulating body;
(4) a metal pellet passing through the slot being plated with the insulating body to form a metal layer with a specific shape by a method of a physical plating membrane;
(5) taking the shelter off; and
(6) the insulating body being intruded into chemical liquid so that the metal layer of the insulating body being plated with at least one metal layer for protection.

11. The manufacture process of the connector as claimed in claim 10, wherein the metal pellet is made of copper.

12. The manufacture process of the connector as claimed in claim 10, wherein the outside of the protecting metal layer is plated with a layer of gold.

13. The manufacture process of the connector as claimed in claim 10, wherein the insulating body has an upper surface and a down surface; and the upper surface and the down surface are plated with metal layers.

14. The manufacture process of the connector as claimed in claim 10, wherein the insulating body has a passing hole; the passing hole is plated with a meter layer and is connected to the metal layers of the upper surface and the down surface of the insulating body.

15. The manufacture process of the connector as claimed in claim 10, wherein the insulating body has a fixing position devise for fixing with the shelters each other.

16. The manufacture process of the connector as claimed in claim 10, wherein the insulating body is intruded into chemical liquid for processing chemical plating at the step (6).

17. The manufacture process of the connector as claimed in claim 10, wherein a method of physical plating membrane is vacuum splashing plating.
